(19) United States
(12) Patent Application Publication
(10) Pub. No.: US 2018/0013823 A1
(43) Pub. Date: Jan. 11, 2018

(54) PHOTOGRAPHIC HISTORICAL DATA GENERATOR

(71) Applicant: Karim Bakhtyari, Sterling, VA (US)

(72) Inventor: Karim Bakhtyari, Sterling, VA (US)

(21) Appl. No.: 15/203,782

(22) Filed: Jul. 6, 2016

(51) Int. Cl. H04L 29/08; H04W 4/00; H04W 4/02

(52) U.S. Cl. CPC H04L 67/1095; H04W 4/025; H04L 67/1097; H04W 4/001

(57) ABSTRACT

A method and a system are disclosed including a mobile computing device, having a photo history app to obtain various information about a photo to be taken including geolocation data, geographic direction of the photo with respect to its subject, date, time, photographer's information, city name, angle of the picture or video, scene identifier such as a name or other designation of a subject building, park, street, library, courthouse, theater and the like. Taking a picture from an event or a famous person may cause an identification or other relevant information about the event or person to be recorded with the picture. The obtained data may be transmitted to a remote picture processing server with a database for processing to further obtain, from other sources, various statistics about the received picture. The server may return some of the relevant information to the app.

### TECHNICAL FIELD

This application relates generally to photography. More specifically, this application relates to cameras and devices that generate historical data for images they record.

### BRIEF DESCRIPTION OF THE DRAWINGS

The drawings, when considered in connection with the following description, are presented for the purpose of facilitating an understanding of the subject matter sought to be protected.

FIG. 1 shows an embodiment of a network computing environment wherein the disclosure may be practiced;

FIG. 2 shows an embodiment of a computing device that may be used in the network computing environment of FIG. 1;

FIG. 3 shows an example photography of a scene using a mobile device;

FIG. 4 shows an example mobile computing device and an example camera taking pictures and/or video from a subject scene for transmission to a remote server with a database for further processing; and

FIG. 5 shows an example photo history app running on a mobile computing device, such as a smartphone, usable to submit a new photograph of a subject scene to the remote server of FIG. 4 in view of similar photographs of the same scene.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references particular mobile devices such as smart phones, the disclosures may be applicable to other devices such as SLR (Single Lens Reflex) cameras, tablets, laptops, and desktop computers, and the like.

Briefly described, a device and a method are disclosed including a mobile computing device, such as a smartphone, having a photo history app (small mobile software application) configured to run on the smartphone and generate or obtain various information about a photo to be taken by the smartphone including geolocation data, geographic direction of the photo with respect to its subject, date, time, photographer's information such as name and contact information, city name in which photo or video is taken, angle of the picture or video with respect to its subject, scene identifier such as a name or other designation of a subject building, park, street, library, courthouse, theater and the like. In some embodiments, taking video or picture from an event or a famous person may cause an identification or other relevant information about the event or person to be recorded with the video or picture. In various embodiments, such generated or obtained data may be transmitted to a remote picture processing server coupled with a database for processing. Such processing may further generate or obtain, from other local or remote sources, various statistics about the received picture or video and extract or search for other data at the same time the picture was transmitted. The remote picture processing server may in turn return relevant information, in real time or otherwise, to the app running on the mobile device.

With the ubiquity of users' internet access there has been an ever increasing demand for expanded services, functionality, picture sharing, video posting, online storage, relevant advertising and marketing, and the like. Commensurate with this increase in demand, there has been an explosion of information, which ironically, has made it harder to find what the users may be looking for or to know how service and goods providers can effectively reach such users. Accordingly, being able to quickly obtain relevant information about pictures and videos in real time may be highly useful to various disciplines that may use pictorial or visual data for various research projects. For example, someone studying the changes in a city, neighborhood, or building, over time may benefit from multiple pictures and videos taken at different times, from different angles, by different people.

### Illustrative Operating Environment

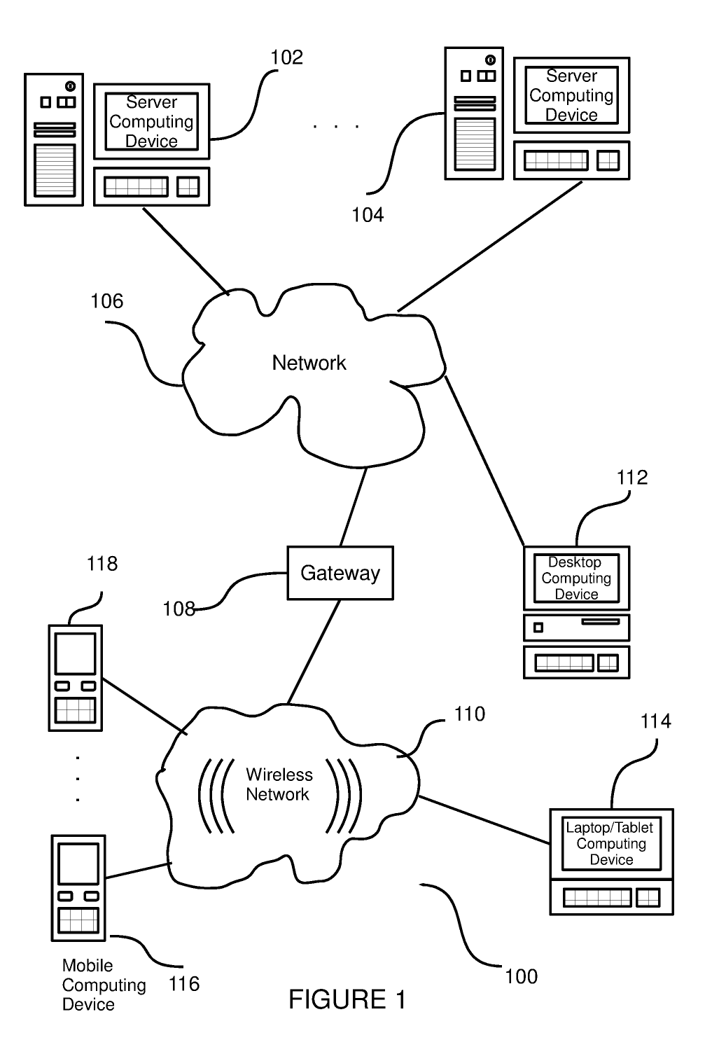

FIG. 1 shows components of an illustrative environment in which the disclosure may be practiced. Not all the shown components may be required to practice the disclosure, and variations in the arrangement and type of the components may be made without departing from the spirit or scope of the disclosure. System 100 may include Local Area Networks (LAN) and Wide Area Networks (WAN) shown collectively as Network 106, wireless network 110, gateway 108 configured to connect remote and/or different types of networks together, client computing devices 112-118, and server computing devices 102-104.

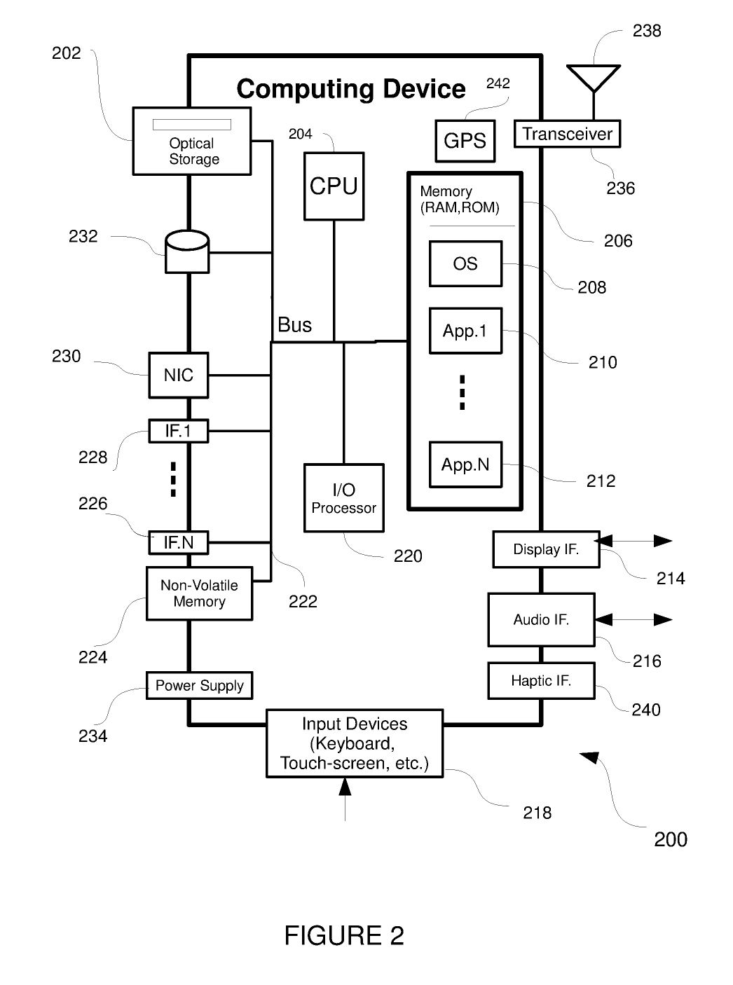

One embodiment of a computing device usable as one of client computing devices 112-118 is described in more detail below with respect to FIG. 2. Briefly, however, client computing devices 112-118 may include virtually any device capable of receiving and sending a message over a network, such as wireless network 110, or the like. Such devices include portable devices such as, cellular telephones, smart phones, display pagers, radio frequency (RF) devices, music players, digital cameras, infrared (IR) devices, Personal Digital Assistants (PDAs), handheld computers, laptop computers, wearable computers, tablet computers, integrated devices combining one or more of the preceding devices, or the like. Client device 112 may include virtually any computing device that typically connects using a wired communications medium such as personal computers, multiprocessor systems, microprocessor-based or programmable consumer electronics, network PCs, or the like. In one embodiment, one or more of client devices 112-118 may also be configured to operate over a wired and/or a wireless network.

Client devices 112-118 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphic may be displayed.

A web-enabled client device may include a browser application that is configured to receive and to send web pages, web-based messages, or the like. The browser application may be configured to receive and display graphic, text, multimedia, or the like, employing virtually any web based language, including a wireless application protocol messages (WAP), or the like. In one embodiment, the browser application may be enabled to employ one or more of Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client computing devices 12-118 also may include at least one other client application that is configured to receive content from another computing device, including, without limit, server computing devices 102-104. The client application may include a capability to provide and receive textual content, multimedia information, or the like. The client application may further provide information that identifies itself, including a type, capability, name, or the like. In one embodiment, client devices 112-118 may uniquely identify themselves through any of a variety of mechanisms, including a phone number, Mobile Identification Number (MIN), an electronic serial number (ESN), mobile device identifier, network address, such as IP (Internet Protocol) address, Media Access Control (MAC) layer identifier, or other identifier. The identifier may be provided in a message, or the like, sent to another computing device.

Client computing devices 112-118 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, to another computing device. However, the present disclosure is not limited to these message protocols, and virtually any other message protocol may be employed.

Client devices 112-118 may further be configured to include a client application that enables the user to log into a user account that may be managed by another computing device. Such user account, for example, may be configured to enable the user to receive emails, send/receive IM messages, SMS messages, access selected web pages, download scripts, applications, or a variety of other content, or perform a variety of other actions over a network. However, managing of messages or otherwise accessing and/or downloading content, may also be performed without logging into the user account. Thus, a user of client devices 112-118 may employ any of a variety of client applications to access content, read web pages, receive/send messages, or the like. In one embodiment, for example, the user may employ a browser or other client application to access a web page hosted by a Web server implemented as server computing device 102. In one embodiment, messages received by client computing devices 112-118 may be saved in non-volatile memory, such as flash and/or PCM, across communication sessions and/or between power cycles of client computing devices 112-118.

Wireless network 110 may be configured to couple client devices 114-118 to network 106. Wireless network 110 may include any of a variety of wireless sub-networks that may further overlay stand-alone ad-hoc networks, and the like, to provide an infrastructure-oriented connection for client devices 114-118. Such sub-networks may include mesh networks, Wireless LAN (WLAN) networks, cellular networks, and the like. Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as client devices 114-118 with various degrees of mobility. For example, wireless network 110 may enable a radio connection through a radio network access such as Global System for Mobil communication (GSM), General Packet Radio Services (GPRS), Enhanced Data GSM Environment (EDGE), WEDGE, Bluetooth, Bluetooth Low Energy (LE), High Speed Downlink Packet Access (HSDPA), Universal Mobile Telecommunications System (UMTS), Wi-Fi, Zigbee, Wideband Code Division Multiple Access (WCDMA), and the like. In essence, wireless network 110 may include virtually any wireless communication mechanism by which information may travel between client devices 102-104 and another computing device, network, and the like.

Network 106 is configured to couple one or more servers depicted in FIG. 1 as server computing devices 102-104 and their respective components with other computing devices, such as client device 112, and through wireless network 110 to client devices 114-118. Network 106 is enabled to employ any form of computer readable media for communicating information from one electronic device to another. Also, network 106 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another.

In various embodiments, the arrangement of system 100 includes components that may be used in and constitute various networked architectures. Such architectures may include peer-to-peer, client-server, two-tier, three-tier, or other multi-tier (n-tier) architectures, MVC (Model-View-Controller), and MVP (Model-View-Presenter) architectures among others. Each of these are briefly described below.

Peer to peer architecture entails use of protocols, such as P2PP (Peer To Peer Protocol), for collaborative, often symmetrical, and independent communication and data transfer between peer client computers without the use of a central server or related protocols.

Client-server architectures includes one or more servers and a number of clients which connect and communicate with the servers via certain predetermined protocols. For example, a client computer connecting to a web server via a browser and related protocols, such as HTTP, may be an example of a client-server architecture. The client-server architecture may also be viewed as a 2-tier architecture.

Two-tier, three-tier, and generally, n-tier architectures are those which separate and isolate distinct functions from each other by the use of well-defined hardware and/or software boundaries. An example of the two-tier architecture is the client-server architecture as already mentioned. In a 2-tier architecture, the presentation layer (or tier), which provides user interface, is separated from the data layer (or tier), which provides data contents. Business logic, which processes the data may be distributed between the two tiers.

A three-tier architecture, goes one step farther than the 2-tier architecture, in that it also provides a logic tier between the presentation tier and data tier to handle application data processing and logic. Business applications often fall in and are implemented in this layer.

MVC (Model-View-Controller) is a conceptually many-to-many architecture where the model, the view, and the controller entities may communicate directly with each other. This is in contrast with the 3-tier architecture in which only adjacent layers may communicate directly.

MVP (Model-View-Presenter) is a modification of the MVC model, in which the presenter entity is analogous to the middle layer of the 3-tier architecture and includes the applications and logic.

Communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 106 may include any communication method by which information may travel between computing devices. Additionally, communication media typically may enable transmission of computer-readable instructions, data structures, program modules, or other types of content, virtually without limit. By way of example, communication media includes wired media such as twisted pair, coaxial cable, fiber optics, wave guides, and other wired media and wireless media such as acoustic, RF, infrared, and other wireless media.

### Illustrative Computing Device Configuration

FIG. 2 shows an illustrative computing device 200 that may represent any one of the server and/or client computing devices shown in FIG. 1. A computing device represented by computing device 200 may include less or more than all the components shown in FIG. 2 depending on the functionality needed. For example, a mobile computing device may include the transceiver 236 and antenna 238, while a server computing device 102 of FIG. 1 may not include these components. Those skilled in the art will appreciate that the scope of integration of components of computing device 200 may be different from what is shown. As such, some of the components of computing device 200 shown in FIG. 2 may be integrated together as one unit. For example, NIC 230 and transceiver 236 may be implemented as an integrated unit. Additionally, different functions of a single component may be separated and implemented across several components instead. For example, different functions of I/O processor 220 may be separated into two or more processing units.

With continued reference to FIG. 2, computing device 200 includes optical storage 202, Central Processing Unit (CPU) 204, memory module 206, display interface 214, audio interface 216, input devices 218, Input/Output (I/O) processor 220, bus 222, non-volatile memory 224, various other interfaces 226-228, Network Interface Card (NIC) 320, hard disk 232, power supply 234, transceiver 236, antenna 238, haptic interface 240, and Global Positioning System (GPS) unit 242. Memory module 206 may include software such as Operating System (OS) 208, and a variety of software application programs and/or software modules/components 210-212. Such software modules and components may be stand-alone application software or be components, such as DLL (Dynamic Link Library) of a bigger application software. Computing device 200 may also include other components not shown in FIG. 2. For example, computing device 200 may further include an illuminator (for example, a light), graphic interface, and portable storage media such as USB drives. Computing device 200 may also include other processing units, such as a math co-processor, graphics processor/accelerator, and a Digital Signal Processor (DSP).

Optical storage device 202 may include optical drives for using optical media, such as CD (Compact Disc), DVD (Digital Video Disc), and the like. Optical storage devices 202 may provide inexpensive ways for storing information for archival and/or distribution purposes.

Central Processing Unit (CPU) 204 may be the main processor for software program execution in computing device 200. CPU 204 may represent one or more processing units that obtain software instructions from memory module 206 and execute such instructions to carry out computations and/or transfer data between various sources and destinations of data, such as hard disk 232, I/O processor 220, display interface 214, input devices 218, non-volatile memory 224, and the like.

Memory module 206 may include RAM (Random Access Memory), ROM (Read Only Memory), and other storage means, mapped to one addressable memory space. Memory module 206 illustrates one of many types of computer storage media for storage of information such as computer readable instructions, data structures, program modules or other data. Memory module 206 may store a basic input/output system (BIOS) for controlling low-level operation of computing device 200. Memory module 206 may also store OS 208 for controlling the general operation of computing device 200. It will be appreciated that OS 208 may include a general-purpose operating system such as a version of UNIX, or LINUX™, or a specialized client-side and/or mobile communication operating system such as Windows Mobile™, Android®, or the Symbian® operating system. OS 208 may, in turn, include or interface with a Java virtual machine (JVM) module that enables control of hardware components and/or operating system operations via Java application programs.

Memory module 206 may further include one or more distinct areas (by address space and/or other means), which can be utilized by computing device 200 to store, among other things, applications and/or other data. For example, one area of memory module 206 may be set aside and employed to store information that describes various capabilities of computing device 200, a device identifier, and the like. Such identification information may then be provided to another device based on any of a variety of events, including being sent as part of a header during a communication, sent upon request, or the like. One common software application is a browser program that is generally used to send/receive information to/from a web server. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may also be employed. In one embodiment, using the browser application, a user may view an article or other content on a web page with one or more highlighted portions as target objects.

Display interface 214 may be coupled with a display unit (not shown), such as liquid crystal display (LCD), gas plasma, light emitting diode (LED), or any other type of display unit that may be used with computing device 200. Display units coupled with display interface 214 may also include a touch sensitive screen arranged to receive input from an object such as a stylus or a digit from a human hand. Display interface 214 may further include interface for other visual status indicators, such Light Emitting Diodes (LED), light arrays, and the like. Display interface 214 may include both hardware and software components. For example, display interface 214 may include a graphic accelerator for rendering graphic-intensive outputs on the display unit. In one embodiment, display interface 214 may include software and/or firmware components that work in conjunction with CPU 204 to render graphic output on the display unit.

Audio interface 216 is arranged to produce and receive audio signals such as the sound of a human voice. For example, audio interface 216 may be coupled to a speaker and microphone (not shown) to enable communication with a human operator, such as spoken commands, and/or generate an audio acknowledgement for some action.

Input devices 218 may include a variety of device types arranged to receive input from a user, such as a keyboard, a keypad, a mouse, a touchpad, a touch-screen (described with respect to display interface 214), a multi-touch screen, a microphone for spoken command input (describe with respect to audio interface 216), and the like.

I/O processor 220 is generally employed to handle transactions and communications with peripheral devices such as mass storage, network, input devices, display, and the like, which couple computing device 200 with the external world. In small, low power computing devices, such as some mobile devices, functions of the I/O processor 220 may be integrated with CPU 204 to reduce hardware cost and complexity. In one embodiment, I/O processor 220 may the primary software interface with all other device and/or hardware interfaces, such as optical storage 202, hard disk 232, interfaces 226-228, display interface 214, audio interface 216, and input devices 218.

An electrical bus 222 internal to computing device 200 may be used to couple various other hardware components, such as CPU 204, memory module 206, I/O processor 220, and the like, to each other for transferring data, instructions, status, and other similar information.

Non-volatile memory 224 may include memory built into computing device 200, or portable storage medium, such as USB drives that may include PCM arrays, flash memory including NOR and NAND flash, pluggable hard drive, and the like. In one embodiment, portable storage medium may behave similarly to a disk drive. In another embodiment, portable storage medium may present an interface different than a disk drive, for example, a read-only interface used for loading/supplying data and/or software.

Various other interfaces 226-228 may include other electrical and/or optical interfaces for connecting to various hardware peripheral devices and networks, such as IEEE 1394 also known as FireWire, Universal Serial Bus (USB), Small Computer Serial Interface (SCSI), parallel printer interface, Universal Synchronous Asynchronous Receiver Transmitter (USART), Video Graphics Array (VGA), Super VGA (SVGA), and the like.

Network Interface Card (NIC) 230 may include circuitry for coupling computing device 200 to one or more networks, and is generally constructed for use with one or more communication protocols and technologies including, but not limited to, Global System for Mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wired and/or wireless communication protocols.

Hard disk 232 is generally used as a mass storage device for computing device 200. In one embodiment, hard disk 232 may be a Ferro-magnetic stack of one or more disks forming a disk drive embedded in or coupled to computing device 200. In another embodiment, hard drive 232 may be implemented as a solid-state device configured to behave as a disk drive, such as a flash-based hard drive. In yet another embodiment, hard drive 232 may be a remote storage accessible over network interface 230 or another interface 226, but acting as a local hard drive. Those skilled in the art will appreciate that other technologies and configurations may be used to present a hard drive interface and functionality to computing device 200 without departing from the spirit of the present disclosure.

Power supply 234 provides power to computing device 200. A rechargeable or non-rechargeable battery may be used to provide power. The power may also be provided by an external power source, such as an AC adapter or a powered docking cradle that supplements and/or recharges a battery.

Transceiver 236 generally represents transmitter/receiver circuits for wired and/or wireless transmission and receipt of electronic data. Transceiver 236 may be a stand-alone module or be integrated with other modules, such as NIC 230. Transceiver 236 may be coupled with one or more antennas for wireless transmission of information.

Antenna 238 is generally used for wireless transmission of information, for example, in conjunction with transceiver 236, NIC 230, and/or GPS 242. Antenna 238 may represent one or more different antennas that may be coupled with different devices and tuned to different carrier frequencies configured to communicate using corresponding protocols and/or networks. Antenna 238 may be of various types, such as omni-directional, dipole, slot, helical, and the like.

Haptic interface 240 is configured to provide tactile feedback to a user of computing device 200. For example, the haptic interface may be employed to vibrate computing device 200, or an input device coupled to computing device 200, such as a game controller, in a particular way when an event occurs, such as hitting an object with a car in a video game.

Global Positioning System (GPS) unit 242 can determine the physical coordinates of computing device 200 on the surface of the Earth, which typically outputs a location as latitude and longitude values. GPS unit 242 can also employ other geo-positioning mechanisms, including, but not limited to, triangulation, assisted GPS (AGPS), E-OTD, CI, SAI, ETA, BSS or the like, to further determine the physical location of computing device 200 on the surface of the Earth. It is understood that under different conditions, GPS unit 242 can determine a physical location within millimeters for computing device 200. In other cases, the determined physical location may be less precise, such as within a meter or significantly greater distances. In one embodiment, however, a mobile device represented by computing device 200 may, through other components, provide other information that may be employed to determine a physical location of the device, including for example, a MAC (Media Access Control) address.

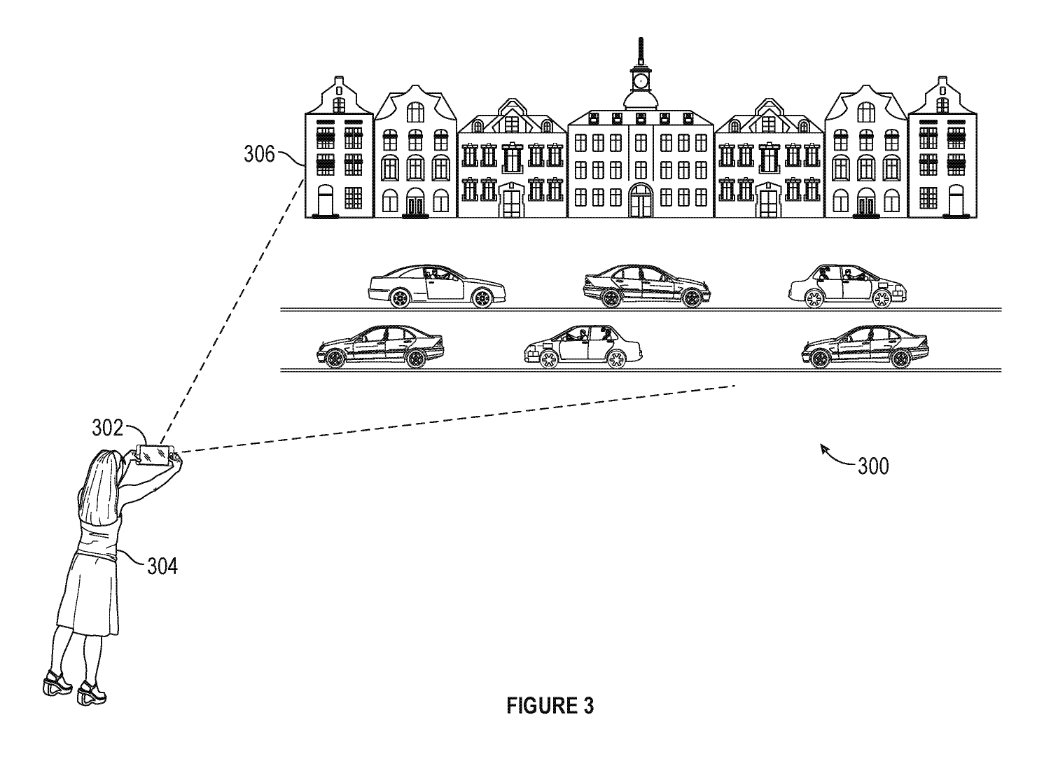

FIG. 3 shows an example photography of a scene using a mobile device. In various embodiments, a photography scene 300 may include a mobile computing device 302, a photographer 304 taking pictures or video from a subject scene 306.

There are many aspects to a scene apart from the subject of photography or video itself. These aspects include the history of the subject, the events and people associated with the subject, the life span of the subject, the changes that have occurred over a given period of time, sudden changes in the subject as a result of a particular event, other pictures or videos of the same subject taken by other photographers from different angles, the relationship of the subject to other subjects and entities in the same locality or other localities or at the same time or at different times, and the like.

As an illustrative example of the various aspects of a photographic subject, consider a city hall building in a particular city. A photographer may take a picture or video from a particular angle from the building. Some local information at the time may be added to the picture or associated with it in a file or database, such as the name or other characteristics of the photographer like age, sex, experience level, reason for taking the picture, and the like. Other such information may include the time, date, subject description, lighting conditions, camera model and/or specifications, and the like.

In various embodiments, the computer network 302 may be the Internet or other private or public computer network suitable for sending digital data, including instant messages or text messages.

In various embodiments, the mobile computing device 302 is substantially similar in function to the computing devices shown in FIGS. 1 and 2. The mobile computing device may be a smart phone, a tablet computer, a laptop computer, a PDA (Personal Digital Assistant) or any other computing device capable of recording and transmitting still or moving images (video). The mobile computing device 302 may also include various apps for various functions such as sending and receiving image data and displaying the same, playing games, weather report, utility software like calculators and camera, and the like. One such app may be a photo history app that may be downloaded for free or for a fee to assist the user in adding to the information associated with an image, as further described herein. In some embodiments, the photo history app software may actually be a webpage loaded onto the mobile computing device where most of its data processing takes place on a remote webserver, while in other embodiments, it may be a locally loaded and executed app.

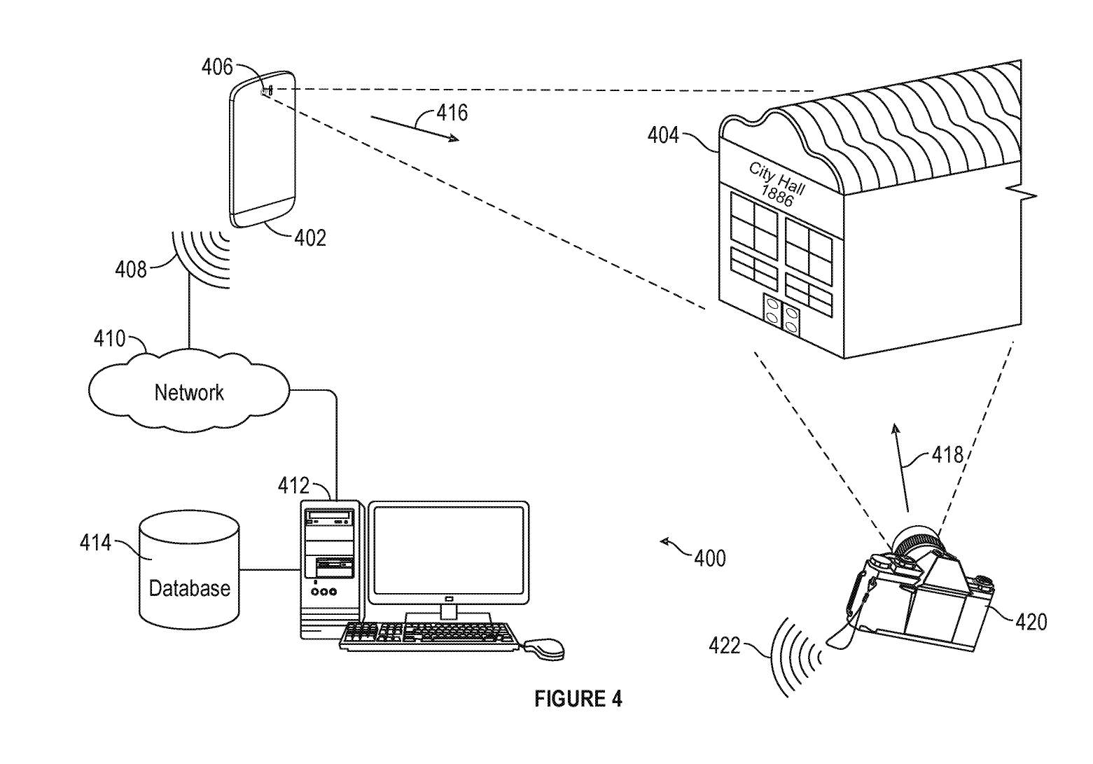

FIG. 4 shows an example mobile computing device and an example camera taking pictures and/or video from a subject scene for transmission to a remote server with a database for further processing. In various embodiments, the photo history system or environment 400 may include a mobile computing device or smartphone 402 pointed at a photography subject 404 along a direction 416, a camera 406 of the mobile device, wireless transmission signal 408 of mobile device for transmitting data to a computer network 410 like the Internet, a remote photo history server computing device 412 coupled with the computer network and also coupled with a database 414, and another dedicated camera device 420 like an SLR camera having wireless signal 422 pointed at the subject 404 at a direction 418.

In various embodiments, the photo history system including a mobile computing device, such as a smartphone 402 may be used to search for, find, generate, create, add, or enhance historical data related to the subject of a picture or video, and stored in a accessible repository such as a database, as further described herein. For example, the subject of a picture may be a building. The photo history system 400 may be used to generate or find information, including other current or older pictures of the same scene or subject as the picture taken by other photographers, events that occurred near or in the building, aerial photographs, and the like, to enhance a data record of the picture. In effect, a database of such photographs is a repository of identifying data related to the photograph and many related, directly or indirectly, relevant information about the same. Such identifying records may be accessed via a website, a subscription service, a pay-per-use service, or any other practical method of accessing extensive historical, related, and identifying data about a photograph, image, video or other visual representations of a given subject such as a place a building, an event, a scene, and the like.

One or more users may take a picture using the smartphone 402 and/or SLR camera 420 of the subject 404, each picture being at a different angle indicated by arrows 416 and 418, respectively. In various embodiments, some information about the picture and/or video from the subject may be entered manually by the user, and/or automatically by a photo history app installed and running on the mobile device (i.e., smartphone, SLR camera, tablet computer, or other similar device) to be associated with the picture. The picture may then be transmitted, by the photo history app via a network interface, to the remote photo history server 412 via network 410 to be stored in database 414 for further processing and access or reference. The photo history app and the photo history server may communicate via a predefined photo history communication protocol or API with each other for the exchange of images and information. The photo history communication protocol may utilize other communication and web protocols such as TCP/IP and HTTP among other known protocols suitable for data exchange.

The photo history server may in turn use this information to update a data record of the same subject in the database. If the photography subject does not exist, the server may create/add a new record for the subject in the database. For example, if the subject is City Hall building in Seattle and there is no existing record in the database, the server may create one and then every time a picture of this building is received, the picture and its associated information are added to the record. In some embodiments, the server itself may add other relevant information to the record. For example, the server may note that a particular picture was taken on the day of elections and add some notes in this regard, add a hotlink to news about the election, or add other references about the subject building. The server may also link the record representing the subject to other database records about the same subject building or other similar ones. For example, the record for the city hall building in Seattle may be linked to database records of other city hall buildings in other cities.

In various embodiments, the photo history app may include a different software component or module for each distinct function. And each module may be part of a bigger program or be an independent background process (i.e., generally not visible or accessible directly by the user) running on the mobile device in communication with the photo history app. One or more functions may be performed by each software component recorded on a computer-readable medium such as a USB disk, optical disk, volatile or non-volatile computer memory, and the like, or transmitted by various communication techniques using various network and/or communication protocols, as described above with respect to FIG. 1. For example, one or more separate software components may be used for each of the functions in the system such as collecting data from the user regarding the image recorded, interacting with a local or remote server and/or database to save the image and corresponding information, setup, user profile creation and/or update for the photographer, user account creation and/or update on the photo history server, presenting images for user review, user interface, sharing related pictures/videos and related events or information with other photographers of the same or similar scene, and the like. Those skilled in the art will appreciate that one function may be implemented using multiple software modules or several functions may be implemented using one software module. With further reference to FIG. 2, these software modules are generally loaded into the memory module 206 of the computing device for execution.

In various embodiments, the mobile device may use a GPS and other location-aware techniques that allow the photo history app to quickly and reliably ascertain the location of the photo being taken. Once this data is transmitted to the remote photo history server, it can relate the photograph to other events and/or pictures related to the same GPS location. When the user moves to a different locality, such as when the user is on a trip, the app may sense the location and adjust the related information and hotlinks used accordingly for any new pictures in the new locality.

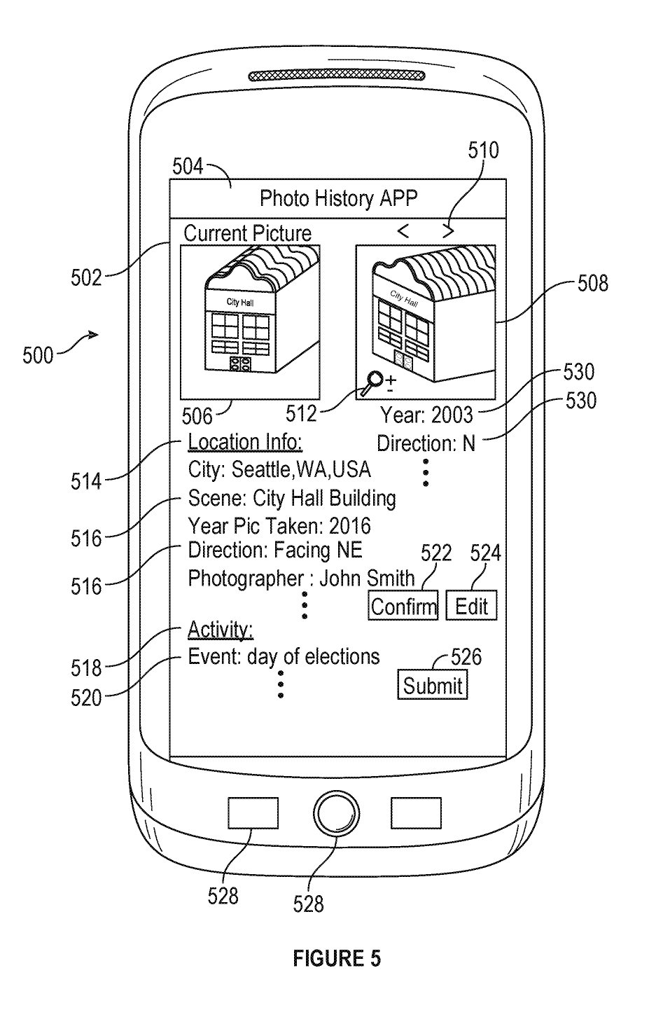

FIG. 5 shows an example photo history app running on a mobile computing device, such as a smartphone, usable to submit a new photograph of a subject scene to the remote server of FIG. 4 in view of similar photographs of the same scene. In various embodiments, photo history computing environment 500 includes a mobile communication device 502, a photo history app 504 configured to run on the mobile device, and hardware and/or software buttons 528 on the mobile device. The app may include a current or recent picture 506, a series of related pictures 508 having selection buttons 510, zoom buttons 512, and related information 530. The photo history app 504 may further include location section 514 with various location-related contents 516, an activity section 518 having various event-related information 520 for the locality shown in location section, a confirm button 522, an edit button 524, and a submit button 526.

In various embodiments, in operation, the photo history app 504 may access and display pictures 506 taken by the mobile device 502 on the app along with related location 514 and event 520 information to be compared or reviewed by the user with other related images 512. The photo history app may communicate with other apps such as a camera app and/or the operating system of the mobile device via predefined software interfaces, API (Application Programming Interface), message passing, shared memory or other techniques of communication and data transfer between apps on the same system or device. In various embodiments, the current picture may be loaded under user control or may be automatically obtained from the local camera memory by the app for review and/or comparison by the user. Other related pictures, such as same scene at different times or from different angles, may be loaded by automatic search by the photo history app or under user control for such comparison. In some embodiments, the user may enter search criteria to direct the photo history app to search and find related images in a certain way. For example, the user may only be interested in pictures of the particular event, or pictures in a particular season, or pictures taken by a particular photographer, or pictures during a particular event, and the like. The photo history app may then use the given criteria to search the database coupled with the remote photo history server to find and retrieve images that match the given criteria for display on the mobile device.

In various embodiments, multiple images and/or events may be fetched by the app for user review. The user may use the selection buttons 510 to move back and forth between various such pictures to review different aspects of the picture with the current one.

In some embodiments, the user may enter and/or correct related information automatically provided by the app and/or the remote server using the edit button 524. The remote server, after appropriate authentication and verification, may update its database records in regards to the scene subject. For example, with reference to the city hall 404 example of FIG. 4, the user may comment or otherwise specify that the current image is a picture of an old city hall not currently in use to correct the identification of the subject building as the current city hall of Seattle. He may further add the picture of the current city hall building as a related image. Alternatively, the user may confirm, using button 522, that the currently listed information is correct and submit the current picture 506 to become part of the database using button 526.

In various embodiments, the photo history app and photo history remote server may provide useful research or hobby services to different photographers, journalists, researchers, historians, artists, politicians, economists, and whoever who could extract useful information from a historical trail of photos or videos from the same scene or region to ascertain how the changes over time have affected their field. For example, historian can see how the demographic has changed in a city square over the past 30 years based on various pictures of the city square by different photographers.

In various embodiments, the information associated with the pictures and/or extracted from and/or generated by studying the pictures/videos can be used in creating various statistics, such as what types of devices are mostly used for different types of photography, what age, sex, nationality, etc. are mostly interested in what types of subjects, how many pictures are taken from a specific subject or location, what angles of a particular subject is most interesting to most people. For example, the study of a city square over time may support a conclusion that most people use their smartphones for selfie (pictures taken by and from the photographer himself/herself by his/her own phone) or pictures of their friends, while pictures of scenery are taken mostly using SLR cameras. Or that males between ages 20 to 35 take more pictures of sports cars than females of the same age. Another use of related pictures is about the photographer himself and what he prefers most to photograph, how, using what types of devices, and the like. Those skilled in the art will appreciate that many such statistics may be obtained by studying and/or analyzing multiple pictures taken over time by different photographers from the same scene.

It will be understood that each step of the processes described above, and combinations of steps, may be implemented by computer program instructions. These program instructions may be provided to a processor to produce a machine, such that the instructions, which execute on the processor, enable implementing the actions specified. The computer program instructions may be executed by a processor to cause a series of operational steps to be performed by the processor to produce a computer implemented process such that the instructions, which execute on the processor to provide steps for implementing the actions. The computer program instructions may also cause at least some of the operational steps to be performed in parallel. Moreover, some of the steps may also be performed across more than one processor, such as might arise in a multi-processor computer system. In addition, one or more steps or combinations of steps described may also be performed concurrently with other steps or combinations of steps, or even in a different sequence than described without departing from the scope or spirit of the disclosure.

Accordingly, steps of processes or methods described support combinations of techniques for performing the specified actions, combinations of steps for performing the specified actions and program instruction for performing the specified actions. It will also be understood that each step, and combinations of steps described, can be implemented by special purpose hardware based systems which perform the specified actions or steps, or combinations of special purpose hardware and computer instructions.

It will be further understood that unless explicitly stated or specified, the steps described in a process are not ordered and may not necessarily be performed or occur in the order described or depicted. For example, a step A in a process described prior to a step B in the same process, may actually be performed after step B. In other words, a collection of steps in a process for achieving an end-result may occur in any order unless otherwise stated.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

What is claimed is:

1. A mobile communication device comprising:
a Central Processing Unit (CPU);
a memory module coupled with the CPU and configured to hold and execute a software application (app); and
a photo history app deployed within the memory module configured to collect an image, add information to it, and transmit it to a remote photo history server.

2. The mobile communication device of claim 1, further comprising a camera and a Network Interface Card (NIC).

3. The mobile communication device of claim 1, wherein the mobile communication device is one of a smartphone and a camera.

4. The communication system of claim 1, wherein the photo history app is configured to communicate with a camera app of the mobile communication device to obtain pictures taken by the camera app.

5. The communication system of claim 1, wherein the photo history app is in communication with the history server to transmit and receive images and information associated with the images.

6. The communication system of claim 1, wherein the photo history app is configured to present a user interface to receive input from a user regarding information associated with an image.

7. The communication system of claim 1, wherein the photo history app is configured to automatically associate location-based information with an image.

8. The communication system of claim 1, wherein the photo history app is configured to receive images other than those taken by the mobile communication device from the photo history server.

9. An image data enhancement system comprising:
a mobile computing device having a Central Processing Unit (CPU) and a memory module;
a photo history server computing device; and
a photo history software application (app) deployed within the memory of the mobile computing device and configured to communicate with the photo history server computing device.

10. The image data enhancement system of claim 9, further comprising a database coupled with the photo history server computing device.

11. The image data enhancement system of claim 9, wherein the photo history server and the photo history app exchange images and related information.

12. The image data enhancement system of claim 9, wherein the photo history server updates database records for newly received images of a same scene.

13. The image data enhancement system of claim 9, wherein a user of the mobile computing device is one of a smartphone and a camera.

14. The image data enhancement system of claim 9, wherein the photo history server adds events that occurred at a site of an image to a database record of the image.

15. The image data enhancement system of claim 14, wherein the app automatically adds information related to an image recorded by the mobile computing device.

16. A method of enhancement of images, the method comprising:
using a mobile computing device to record an image;
accessing the recorded image by a photo history software application (app);
adding information related to the recorded image by the photo history app; and
transmitting the recorded image and the added information to a photo history server.

17. The method of claim 16, further comprising creating a new or updating an existing database record for the recorded image by the photo history server.

18. The method of claim 16, wherein the information related to the recorded image comprises at least one of location, time, and description of a subject of the recorded image.

19. The method of claim 16, wherein the photo history server searches and finds other images of a same subject of the recorded image and associates the other images with the recorded image.

20. The method of claim 16, wherein the photo history server sends other images of a same subject as the subject of the recorded image to the photo history app.
